(19) United States
(12) Patent Application Publication
(10) Pub. No.: US 2026/0262676 A1
(43) Pub. Date: Sep. 10, 2026

(54) CONFECTIONERY

(71) Applicant: SOCIÉTÉ DES PRODUITS NESTLÉ S.A., Vevey (CH)

(72) Inventors: Aristodimos LAZIDIS, York (GB); David STOKES, York (GB)

(21) Appl. No.: 19/161,148

(22) PCT Filed: Mar. 1, 2024
(86) PCT No.: PCT/EP2024/055488

§ 371 Date: Aug. 29, 2025

(30) Foreign Application Priority Data
Mar. 1, 2023 (EP) 23159511.7

(51) Int. Cl. A23G 1/54; A23G 3/40; A23G 3/42; A23G 3/44; A23G 3/54

(52) U.S. Cl. CPC A23G 1/545; A23G 3/40; A23G 3/42; A23G 3/44; A23G 3/545

(57) ABSTRACT

The invention relates to a confectionery composition and methods of making the same. In particular, the invention relates to confectionery fillings comprising water, sugar fat, hydrocolloid and protein. Also provided is a process for the manufacture of a confectionery composition.

### FIELD OF THE INVENTION

This invention relates to a confectionery composition and methods of making the same. In particular, the invention relates to a filling for a confectionery product, the filling comprising a fat phase, a water phase comprising one or more sugars, starch and protein.

### BACKGROUND OF THE INVENTION

Many confectionery products comprise a soft filling within an edible container such as a chocolate shell or a jelly. Confectionery fillings are typically water-based or fat-based. Water and fat, of course, do not mix easily.

Fat-based fillings are often used in confectionery. However, from a nutritional point of view, fat-based fillings contain saturated fatty acids (SFA) and generally have higher calorific value than sugars, which are the main constituent of water-based systems. Additionally, fat-based fillings often have a ‘heavy’ texture which may not be desirable to all consumers.

Water-based filling systems typically have lower fat and higher sugar content than fat-based fillings. These water-based fillings have a lighter and softer perception than fat-based fillings, are free of SFA and have lower calorific value. The main benefit of water-based confectionery fillings is that they have a soft texture that can be easily modulated with the use of a hydrocolloid. They also deliver very efficiently water-based flavours such as those from fruits, coffee and caramel. Finally, they do not contribute to the fat or SFA content of the product and have a lower price than vegetable fats. However, water-based fillings are not generally microbiologically stable, difficult to deposit and cannot provide the range of textures that are achievable using fats.

The present invention provides fillings with new innovative textures that are able to mimic the taste and mouthfeel of desserts, typically associated with being chilled and requiring a spoon to eat. It is known in the art to have confectionery products in both tablets and gifting formats dedicated to fillings inspired from desserts. So far, the technical solution to enable this has been the use of fat-based fillings that contain flavourings and inclusions to imitate popular desserts (e.g. Crème brûlée, paris best, tiramisu etc.). In terms of eating experience, the products provide little excitement especially in terms of texture since they are overpowered by the fat matrix. Whilst the use of a fat matrix offers certain advantages from a manufacturing and shelf-life point of view (e.g. handling during production similar to chocolate and long term stability due to practical absence of moisture) it does not deliver the promise advertised on pack to the consumer.

There remains a need for improved foods with textures and appearances that are appealing to consumers while having capable of being manufactured industrially and storage characteristics.

The present invention provides water-based fillings with a tuneable texture that are created utilising emulsion technology. The fillings prepared with the proposed solution have an overall lower raw material cost compared to similar fat-based fillings. The fillings are stable microbiologically for at least 12 months whilst also maintaining their structural stability. Additionally, the fillings have a reduced risk of bloom, an area that filled products can typically suffer with when the filling has a high fat content, as compared to traditional fat-based fillings.

As discussed above, water based and fat-based fillings are known in the art as evidenced by the patents referenced below.

WO-A-2010/054516 describes a confectionery comprising a liquid center (filling) composition and a shell surrounding the liquid center. The liquid center includes a bulk sweetener and a fat having a slip melting point of 10 to 18° C. The shell comprises a shell composition including less than or equal to 20 weight percent total fat based on the total weight of the shell composition.

WO-A-2007/051816 describes a non-dairy food composition based on an oil-in-water emulsion containing sugar and carbohydrates, characterized in that its water activity is of between 0.5 and 0.75 and its dry matter content is of between 80 and 95% by weight based on the total weight of the food composition, in that it contains non-gelatinized starch whose particles size is below 10 μm, in that the composition is free from fat separation and in that the composition is stable at a temperature of between 1 and 15° C. for at least 6 weeks. It also concerns its process of preparation.

WO-A-2016/106282 describes a stable emulsion of an aqueous phase in a lipid phase wherein non-fatty cocoa solids and/or non-fatty milk solids are present in the lipid phase. The disclosure further relates to a process for making an emulsion, said process comprising adding the lipid phase in two steps.

### SUMMARY OF THE INVENTION

The invention relates to a confectionery composition, preferably a filling for confectionery applications. The filling comprises water, fat and sugar. The largest component of the filling is the water-phase, so the filling may be described as water-based. In particular, the invention provides a filling for confectionery comprising a combination of water, fat, sugar, hydrocolloid and protein.

In an aspect, the present invention provides a confectionery composition comprising hydrocolloid in an amount of 0.1 wt % to 10 wt %, protein in an amount of 0.5 wt % to 15 wt %, water in an amount of 10 wt % to 40 wt %, sugar in an amount of 30 wt % to 80 wt % and fat in an amount of 2 wt % to 35 wt %, relative to the weight of the confectionery composition.

In an aspect, the present invention provides a confectionery composition comprising hydrocolloid in an amount of 0.1 wt % to 5 wt %, protein in an amount of 0.5 wt % to 6.5 wt %, sugar in an amount of 30 wt % to 67 wt % and fat in an amount of 2 wt % to 49 wt %, relative to the weight of the confectionery composition. Water may be present in an amount of 10 wt % to 20 wt %.

In an aspect, the present invention provides a confectionery composition comprising hydrocolloid in an amount of 0.1 wt % to 10 wt %, protein in an amount of 1.7 wt % to 15 wt %, sugar in an amount of 29.7 wt % to 80 wt % and fat in an amount of 2 wt % to 35 wt %, relative to the weight of the confectionery composition. Water may be present in an amount of 10 wt % to 40 wt %.

In an aspect, the present invention provides a confectionery composition comprising hydrocolloid in an amount of 0.1 wt % to 5 wt %, protein in an amount of 1.7 wt % to 6.5 wt %, sugar in an amount of 29.7 wt % to 67 wt % and fat in an amount of 2 wt % to 49 wt %, relative to the weight of the confectionery composition. Water may be present in an amount of 2 wt % to 20 wt %. In an aspect, the present invention provides a confectionery composition comprising hydrocolloid in an amount of 0 wt % to 5 wt %, protein in an amount of 1.7 wt % to 6.5 wt %, sugar in an amount of 29.7 wt % to 67 wt %, fat in an amount of 2 wt % to 49 wt %, water in an amount 2 wt % to 20 wt %, wherein the percentages are the weight percentages of the confectionery composition.

In an aspect, the present invention provides a confectionery composition comprising substantially the same recipe as shown in any one of Examples 31, 32, 33, 34, 35, 36, 37, or 38. In this context, substantially the same means that the ingredient amounts do not vary by more than 20%, or by more than 15%, or by more than 10%, or by more than 5% from the ingredient amounts shown.

In a further aspect, the present invention provides a process comprising, consisting or consisting essentially of the following steps:
Providing an aqueous solution of sugar;
Addition of hydrocolloid and protein to the aqueous solution of sugar
Addition of fat and any other ingredients to form a mixture;
Blending the mixture, preferably to provide a mixture with the viscosity of between 4 and 40 Pa·S⁻¹ when measured at 25° C.

An additional aspect of the invention provides a finished confectionery product comprising a confectionery composition according to the first aspect, that is partly or completely surrounded or encased in chocolate, preferably a chocolate shell.

### DETAILED DESCRIPTION OF THE INVENTION

The present inventors have developed an indulgent confectionery filling using a combination of water, fat and sugar, and typically also one or both of protein and hydrocolloid. Such fillings are desired by consumers, in particular within chocolate products.

This confectionary composition is notable because confectionery fillings typically contain water or fat, which do not usually combine. One exception to the general rule that water and fat do not combine in confectionery fillings is caramel, but that has a lower percentage of fat than is required in many fillings and that is provided by the present invention.

The inventors have also devised a process wherein a water continuous mass is provided, to which fat is added and emulsified. The combination of ingredients provided by the present invention stabilises the fats in the system to allow the production of industrially applicable filling compositions.

The water-phase/fat-phase combination approach provided by the present invention allows the fillings to be both lower in fat and sugar than typical fat based fillings, whilst still being perceived by consumers as indulgent.

The present invention allows water-based fillings with a thick, creamy texture to be provided by pairing a water-phase with a fat-phase. The texture is achieved by the combination of ingredients of the present invention. Empirically, this texture may preferably be defined by a certain viscosity range. Additionally, compositions outside of the invention may have a viscosity that prohibits industrial manufacture and a pleasant consumption experience.

In preferred embodiments, the confectionery composition has a bulk viscosity of at least 4 Pa·S, for example from 4 Pa·S to 40 Pa·S or preferably 7 to 37 Pa·s. More preferably, the confectionery composition has a viscosity from 10 to 37 Pa·S, most preferably 10 to 35 Pa·S or 10 to 32 Pa·S.

The viscosity recited above is preferably assessed as follows, preferably at 25° C. Rheological properties of the masses were measured by performing oscillatory rheolometry. These measurements were performed using a Physica MRC 500 rheometer (Anton Paar) equipped with a sanded Couette geometry (CC27-SN23479) and a Peltier system for temperature control. The Couette geometry was composed of a cup (14.46 mm radius) and a bob system (13.33 mm radius, 40 mm length). Samples were covered with a low-viscosity silicone oil (Sigma Aldrich Ltd, Singapore) to avoid evaporation during measurements. The sample rested for 5 minutes at 25° C. before starting the experiments. The imposed frequency (1 Hz) and strain (0.5%) during oscillatory shear measurements were chosen within the linear response regime.

The confectionery composition is preferably a confectionery filling. The filling may in some embodiments be a liquid preferably not aerated and so not a mousse or foam.

In an embodiment the confectionery composition can be aerated. For example, the confectionery filling can be aerated and have an overrun of at least 1%, 2%, 5%, 10%, 15%, 20% or 30%. In some embodiments the confectionery filling can be very significantly aerated with an overrun of at least 50%, for example around 100% or more. In some embodiments the confectionery filling can be aerated with an overrun of equal to or less than 250%, for example, less than 225%, less than 200%, less than 175%, less than 150% or less than 125%. In some embodiments the confectionery filling can be aerated with an overrun between 1% and 250%, between 10% and 200%, between 20% and 150% or between 30% and 100%.

The percentage overrun refers to the degree of expansion resulting from the amount of air incorporated into the product during aeration. For example, an overrun of around 100%, means that air makes up 50% of its volume.

The confectionery composition has a water activity below 0.70, preferably above 0.45 and below 0.70. In some embodiments, the confectionery composition has a water activity of no greater than 0.69, no greater than 0.68, or no greater than 0.67. The water activity is preferably greater than 0.50. The water activity may be between 0.6 and 0.69, for example around 0.65, in some embodiments. Suitable water activities according to the invention include 0.69, 0.68, 0.67, 0.66, 0.65, 0.64, 0.63, 0.62, 0.61 and 0.60. Preferred water activities include 0.69, 0.68, 0.67, 0.66, and 0.65.

The term water activity (“Aw”) is well known in the art, and refers to the partial vapor pressure of water in a solution divided by the standard state partial vapor pressure of water. In the field of food science, the standard state is most often defined as the partial vapor pressure of pure water at the same temperature. Using this particular definition, pure distilled water has a water activity of exactly one. A water activity of 0.80 means the vapor pressure is 80 percent of that of pure water. Water activity values are preferably obtained by either a resistive electrolytic, a capacitance or a dew point hygrometer, as known in the art. Water activity values according to the invention can be determined by enclosing a sample in a sealed container. The relative humidity of the air in the headspace will equilibrate with the water activity of the sample. At equilibrium, the two will be equal, and the relative humidity of the headspace can be measured using an electrical capacitance sensor to determine the water activity of the sample. In a preferred embodiment, the water activity is measured using water activity meter (for example from Novasina). It defines the water activity by measuring the vapour pressure of a sample of the composition in closed chamber once equilibrium is reached. The vapour pressure is defined using a resistive-electrolytic sensor.

The confectionery composition may comprise one or more flavourings. Suitable flavourings will be apparent to the skilled person, and include coffee, chocolate, caramel, fruit juices and flavourings, and malt extract.

In some embodiments, the confectionery composition comprises cocoa powder. In some embodiments, the confectionery composition comprises cocoa powder and the fat phase comprises all vegetable fats, thereby providing a vegan composition.

### Hydrocolloid

The compositions of the present invention comprise hydrocolloids of between 0.1% wt and 10% wt. The compositions of the present invention may comprise hydrocolloids of between 0.1% wt and 5% wt. The compositions of the present invention may comprise hydrocolloids of greater than 0 wt % but less than 0.1% wt. The compositions of the present invention may comprise hydrocolloids of greater than 5% wt but less than or equal to 10% wt.

In some embodiments, the confectionery composition comprises 0.2 wt % to 5.0 wt % hydrocolloid. In preferred embodiments, the hydrocolloid is present at between 0.3 wt % and 5.0 wt %, preferably between 0.3 wt % and 4.0 wt %, most preferably between 0.5 wt % and 3.5 wt %. The hydrocolloid ingredient is preferably a starch.

The starch ingredient is preferably present as 0.1 wt % to 5 wt % of the total ingredients.

The starch is preferably a speciality starch that is physically modified and/or pregelatinised.

Pregelatinized starch is starch which typically has been cooked and then dried in the starch factory on a drum dryer or in an extruder making the starch cold-water-soluble. Spray dryers are used to obtain dry starch sugars and low viscous pregelatinized starch powder.

Pregelatinization gives native and stabilized starches the ability to form a cold-water paste. Accordingly, pre-gelatinised starch dissolves in cold liquids and becomes viscous (like gelatine). It is used for thickening and binding products, as well as a filling ingredient in pharmaceutical tablets. Other names for this product include: pre-gelatinised modified starch, pre-gelatinised food starch, modified starch, instant starch, soluble starch and pregel/prejel starch.

Preferred starches include corn starch, in particular pre-gelatinised corn starch, and maize starch, for example cold water swelling waxy maize starch such as NOVATION® Lumina 4600 starch commercially available from Ingredion Germany GmbH (Hamburg, Germany). Chemically modified starches may also be used according to the invention, such as hydroxypropyl distarch phosphate (E1442) starch commercially available from Ingredion Germany GmbH (Hamburg, Germany). Chemical modification of starch is well-known in the art and is generally achieved through derivatization, such as etherification, esterification, or cross-linking. Chemical modification of starch is typically employed to optimize the structural characteristics and functional and nutritional properties for targeted applications.

Native starches, even when gelatinised, are not preferred due to lower solubility and ability to form a viscous paste in cold liquids.

Instead of starch, other hydrocolloids can be used, for example pectin, such as low methoxyl pectin, citrus fibres, agar, gelatine, kappa carrageenan, alginate, gelan, or locust bean gum.

### Fats

The present invention provides a composition that provides a total amount of fat between 2 wt % and 35 wt %. The present invention provides a composition that may provide a total amount of fat between 2 wt % and 49 wt %.

In an embodiment, the confectionery composition comprises a total amount of fat between 4 wt % and 34 wt %, for example between 5 wt % and 33 wt %. In some embodiments, the fats are present at between 6 wt % and 32 wt %. In preferred embodiments, the fats are present at between 6.0 wt % and 31 wt %, preferably between 6 wt % and 30 wt %, most preferably between 7 wt % and 29 wt %.

The fat is preferably present as a fat phase within the mixture of ingredients of the composition. Fat may also be present inherently within other ingredients of the composition (such as in chocolate).

The fat phase is preferably present between 3 wt % and 30 wt % of the confectionery composition. The range may in some embodiments be between 3.5 wt % and 30 wt % or 4 wt % and 30 wt %.

In an embodiment, the confectionery composition comprises a fat phase of between 5 wt % and 30 wt %, for example between 5.5 wt % and 30 wt %. In some embodiments, the fats are present at between 6 wt % and 30 wt %. In preferred embodiments, the fats are present at between 6.0 wt % and 29.5 wt %, preferably between 6 wt % and 29.0 wt %, most preferably between 7 wt % and 28 wt %.

In some embodiments, the fat phase comprises, consists or consists essentially of filling fat, milk fat and/or nut butter. Filling fats are known in the art, and examples include non-hydrogenated, non-lauric fats such as the Ertifil Max filling fats available from Fuji Oil Europe (Gent, Belgium). The examples below primarily use a filling fat. A person skilled in the art would understand the types of fat categorised under filling fats as this is a commonly used term in confectionery. Several filling fats have been successfully tested by the inventors, including non-hydrogenated, non-lauric fats such as Ertifil Max 170, and vegetable fats such as Chocofil TC50 (AAK) and cocoa butter, as well as milk fats such as anhydrous milk fat.

In the present invention, a filling fat is preferably defined as a fat which is nominally solid at ambient temperatures of around 20° C.; therefore a fat that that has an SFC at 20° C. of at least 10%.

In a preferred embodiment, the composition of the present invention comprises a fat phase provided by the fats used to make the composition i.e., isolated fats or fats added in an accessible form to the mixture.

Without being bound by theory, it is believed that it is preferable for the fats in the composition of the present invention to comprise fats of a certain solid fat content to aid reduction of oiling out and composition stability. Solid Fat Content (SFC) is the widely accepted analysis of fats and oils in the food industry. SFC is typically determined using nuclear magnetic resonance (NMR) where it is based on a direct ratio measurement between the solid and liquid parts of the sample observed in the NMR Free Induction Decay (FID). The official standard for measuring SFC is IUPAC 2.150 (Europe). Solid fat content of the fats in the present invention has been determined using the method described below:

For IUPAC, 2.150A, 80° C.=30 mins, 30° C.=10 mins, 0° C.=30 mins, Each Temperature=30 mins then take a reading.

For IUPAC, 2.150B, the information was taken from the supplier's product specification.

In respect of the choice of which IUPAC method to use when assessing the SFC, we note that the person skilled in the art is aware of which method is applicable to which type of fat. In general, when a fat requires tempering, i.e. the fat composition is subjected to thermal treatment, in particular to a cooling and heating programme which is adapted to the nature of the fat, so as to promote crystallisation of the fat in a stable crystalline form. In particular within the scope of the present invention, where the solid fat content is measured with IUPAC method 2.150 a, the fat composition is not required to be subjected to thermal treatment. IUPAC method 2.150b requires the fat composition being subjected to the thermal treatment programme described in that method.

In a particularly preferred embodiment, the composition comprises a fat with an SFC at 20° C. of at least 10%.

In a preferred embodiment, the composition comprises a fat with a SFC at 20° C. of between 10% and 95%, preferably between 15% and 90%, more preferably between 15% and 87.5%, most preferably between 15% and 85%.

In a preferred embodiment, the composition comprises a fat with a SFC at 25° C. of between 1% and 85%, preferably between 3% and 82%, more preferably between 6% and 78%, most preferably between 5% and 75%.

In a preferred embodiment, the composition comprises a fat with a SFC at 30° C. of between 1% and 75%, preferably between 1% and 70%, more preferably between 2% and 65%, most preferably between 3% and 60%.

In a preferred embodiment, the above defined fat is present in an amount by weight of the composition of between 2.0 wt % and 35.0 wt %, preferably between 2.5 wt % and 33 wt %, preferably between 4.0 wt % and 30 wt %, most preferably from 7.0 wt % to 28 wt %.

In an embodiment of the invention, the fat used may comprise other fats typically used in confectionery. For example, selected from the group comprising of milk fat, coconut oil, palm kernel oil, palm oil, cocoa butter, butter oil, lard, tallow, oil/fat fractions such as lauric, stearin or olein fractions, hydrogenated oils (partial and full hydrogenation, shea fat, cocoa butter extender fats (for example, approved fats: illipe, kokum gurgi, mango, sal), inter-esterified fats (could be any fats and oils and could be either chemical or enzymatic inter-esterification), and a blend of at least two of the above. In further embodiments, the fat may also comprise nut butters and/or pastes. In a preferred embodiment, the nut butters and pastes can be selected from coconut, almond or hazelnut paste. The fat may comprise or consist of anhydrous milk fat, chocolate (milk, dark or white) or cocoa liquor.

In an embodiment, the vegetable fat is palm oil or a blend of palm oil and shea stearin.

### Water Phase

The present invention provides a composition that comprises water in an amount of between 10 wt % and 40 wt %, for example between 10 and 20 wt %.

In an embodiment, the confectionery composition comprises 2 wt % to 40 wt % water, or 2 wt % to 36 wt % water, or 2 wt % to 34 wt % water, or 2 wt % to 30 wt % water, or 2 wt % to 26 wt % water, or 2 wt % to 22 wt % water.

In an embodiment, the confectionery composition comprises 10 wt % to 40 wt % water, or 10 wt % to 36 wt % water, or 10 wt % to 34 wt % water, or 10 wt % to 30 wt % water, or 10 wt % to 26 wt % water, or 10 wt % to 22 wt % water. In an embodiment, the confectionery composition comprises 3 wt % to 21 wt % water. In an embodiment, the confectionery composition comprises 4 wt % to 22 wt % water. In an embodiment, the confectionery composition comprises 5 wt % to 23 wt % water. In an embodiment, the confectionery composition comprises 6 wt % to 24 wt % water. In an embodiment, the confectionery composition comprises 7 wt % to 25 wt % water. In an embodiment, the confectionery composition comprises 8 wt % to 26 wt % water. In an embodiment, the confectionery composition comprises 9 wt % to 27 wt % water. In an embodiment, the confectionery composition comprises 10 wt % to 28 wt % water. In an embodiment, the confectionery composition comprises 11 wt % to 29 wt % water. In an embodiment, the confectionery composition comprises 12 wt % to 30 wt % water. In an embodiment, the confectionery composition comprises 13 wt % to 31 wt % water. In an embodiment, the confectionery composition comprises 14 wt % to 32 wt % water. In an embodiment, the confectionery composition comprises 15 wt % to 33 wt % water. In an embodiment, the confectionery composition comprises 16 wt % to 34 wt % water. In an embodiment, the confectionery composition comprises 17 wt % to 35 wt % water. In an embodiment, the confectionery composition comprises 18 wt % to 36 wt % water. In an embodiment, the confectionery composition comprises 19 wt % to 37 wt % water. In an embodiment, the confectionery composition comprises 20 wt % to 38 wt % water. In an embodiment, the confectionery composition comprises 21 wt % to 39 wt % water. In an embodiment, the confectionery composition comprises 22 wt % to 40 wt % water.

In an embodiment, the confectionery composition comprises 10 wt % to 40 wt % water, for example water between 10 wt % and 37.5 wt %. In some embodiments, the water is present at between 10 wt % and 35 wt %. In preferred embodiments, the water is present at between 10 wt % and 33 wt %, preferably between 11 wt % and 31 wt %, most preferably between 12 wt % and 30 wt %.

Water and ingredients that are soluble in water are present as a water phase in the composition of the present invention. These are termed water-phase ingredients.

The water phase ingredients are preferably present between 50 wt % and 95 wt % of the composition. The range may in some embodiments be between 52 wt % and 90 wt %, preferably 55 wt % and 87 wt %, or most preferably between 55 wt % and 85 wt %.

The water phase preferably comprises one or more sugars, which may comprise one or more sugar syrups, and optionally water.

The desired profile can be achieved with glucose-fructose syrup, partially inverted syrup or adding powdered sucrose, dextrose and fructose.

In a preferred embodiment, the water content of the present invention is measured using Karl Fischer titration.

In preferred embodiments, the water phase comprises one or more sugars and water, although in some embodiments water is not needed as a separate ingredient and the aqueous component is provided by one or more sugar syrups. Sugar syrup usually contains around 20 wt % to 30 wt % water or around 20 wt % to 25 wt % water, for example around 23 wt % of the exemplified inverted “IS221” syrup is water.

In certain embodiments, the sugar component comprises or consists of at least two different sugars. In some embodiments, the sugar component comprises or consists of an invert sugar, optionally with a sugar conversion percentage between 10% and 70%, between 10% and 65%, between 20% and 60%, or between 40% and 60%.

In one embodiment, the blend of different sugars is provided by an invert sugar with a sugar conversion percentage (i.e. degree of hydrolysis) at least 10% but below 70%, below 60%, below 50% or below 40%. In some embodiments, the sugar is an invert sugar with a sugar conversion percentage (i.e. degree of hydrolysis) of 20% to 60%, 30% to 50% or 40% to 50%. Invert sugars with incomplete conversion (hydrolysis) are known as partial invert sugars.

This mixture of sugars in the confectionery may comprise a mixture of at least one reducing sugar and at least one non-reducing sugar. Sucrose is a non-reducing sugar while dextrose and fructose are reducing sugars. A partial invert syrup comprises sucrose (non-reducing), dextrose (reducing) and fructose (reducing).

In the present invention, the composition comprises sugar in an amount of 30 wt % to 80 wt %. This is the total sugar amount, i.e. comprises sugars in both the aqueous and fat phases, and inherent in other ingredients (e.g. milk powder, chocolate).

In an embodiment, the confectionery composition comprises 30 wt % to 80 wt % total sugars relative to the composition. For example sugar between 35 wt % and 80 wt %. In some embodiments, the sugar is present at between 35 wt % and 78 wt %, between 35 wt % and 77 wt %, between 35 wt % and 76 wt %, or between 35 wt % and 75 wt %. In a preferred embodiment the confectionery composition comprises sugar between 35 wt % and 70 wt %, preferably between 35 wt % and 65.0 wt %, most preferably between 40 wt % and 60 wt %.

In a preferred embodiment, the sugars in the aqueous phase (i.e. those not present in fat phase or inherent to milk, chocolate, etc.) contribute to the stabilisation system of the present invention.

The definitions below relate to the sugars present in the aqueous phase of the present compositions.

In a preferred embodiment, the sugars present in the aqueous phase contribute from 45 wt % to 100 wt % of the total sugars, preferably from 50 wt % to 100 wt %, more preferably from 55 wt % to 95 wt % or 55 wt % to 100 wt % and more preferably from 60 wt % to 95 wt % or 60 wt % to 100%. In some embodiments, the sugar is a sugar syrup. Suitable sugar syrups include glucose syrup preferably at 40 to 70 Dextrose Equivalent (“DE”), fructose glucose syrup, high fructose syrup, corn syrup, oat syrup, rice syrup or tapioca syrup. A mixture of two or more of these syrups can be used.

Such syrups are well known in the art. Glucose syrups are well known in the art and are obtained by hydrolysis of starches, generally vegetable starches. Glucose syrups are described in Glucose Syrups, Technology and Applications, Peter Hull, Wiley-Blackwell 2010.

In a preferred embodiment, the glucose syrup has a DE value in the range of 35-95, preferably in the range of 35-70 or 40-70, more preferably in the range of 35-63.

Similarly, fructose glucose syrups are prepared from hydrolysis of starch, generally vegetable starches, and then isomerisation to produce fructose. As in the production of conventional corn syrup, the starch may be broken down into glucose by enzymes. To make the fructose corn syrup, the corn syrup is further processed by D-xylose isomerase to convert some of its glucose into fructose. Common commercially used syrups are “HFCS 42” and “HFCS 55” and this nomenclature refers to dry weight fructose compositions of 42% and 55% respectively, the rest typically being glucose or glucose and an amount of other carbohydrates.

In a preferred embodiment, the fructose glucose syrups generally contain between 5 wt % and 75 wt % fructose, preferably between 20 wt % and 70 wt %, more preferably between 30 wt % and 60 wt % and more preferably between 35 wt % and 55 wt %. These percentages are on a dry solids basis.

In a preferred embodiment, the fructose glucose syrups generally contain between 5 wt % and 75 wt % glucose, preferably between 20 wt % and 70 wt %, more preferably between 30 wt % and 60 wt % and more preferably between 35 wt % and 55 wt %. These percentages are on a dry solids basis.

Undesirable crystallisation of the sugar in the confectionery can be avoided when the sugar comprises or consists of at least two different sugars, preferably comprising fructose. A suitable blend of sugars is provided by an invert sugar with a sugar conversion percentage at least 10% but below 70%, below 60%, below 50% or below 40%. A conversion rate of 40% to 50% is shown to provide desirable results in the Examples. In some embodiments, the sugar is an invert sugar with a sugar conversion percentage (i.e. degree of hydrolysis) of 20% to 60%, 30% to 50% or 40% to 50%.

The presence of fructose in the sugar mix is highly preferred and contributes to the hinderance of crystallisation and stability of the aqueous, fat mixtures.

Preferably, from 10 wt % to 50 wt % of the sugar in the aqueous phase (i.e. from 1/10 to ½ of the sugars, preferably at least ⅕) is fructose. More preferably, 15 wt % to 50 wt %, more preferably 20 wt % to 40 wt % and more preferably 20 wt % to 38 wt % of the sugars in the aqueous phase. This can be achieved either by blending different sugar rich ingredients (such as powder sugars, starch derived syrups or inverted sugar syrup) or by using a partially inverted sugar syrup comprising sucrose, dextrose and fructose.

In a preferred embodiment, from 20 wt % to 65 wt % of the sugar in the aqueous phase is glucose (including dextrose and glucose/dextrose mixtures). More preferably, 25 wt % to 65 wt %, more preferably 30 wt % to 60 wt % and more preferably 35 wt % to 55 wt % of the sugars in the aqueous phase.

Due to the dextrorotatory nature of glucose and dextrose, these can be interchanged freely with each other (i.e, when glucose is used this can be fully or partially substituted with dextrose with no observed change in effect). Hence, preferably in this patent the term “glucose” is to be generally read as encompassing glucose and dextrose and mixtures thereof.

In a preferred embodiment, from 0 wt % to 60 wt % of the sugar in the aqueous phase is sucrose. More preferably, 0 wt % to 55 wt %, and 2 wt % to 40 wt % of the sugars in the aqueous phase. The presence of sucrose is less important than the contributions of the fructose disclosed above.

In a preferred embodiment, from 0 wt % to 20 wt % of the sugar in the aqueous phase is maltose. More preferably, 0 wt % to 15 wt % and 2 wt % to 12 wt % of the sugars in the aqueous phase. The presence of maltose is less important than the contributions of the fructose disclosed above.

In a preferred embodiment, the confectionery comprises a sugar mix in the aqueous phase and the confectionery comprises 0 wt % to 30 wt % sucrose, 5 wt % to 30 wt % glucose syrup and 35 wt % to 75 wt % fructose glucose syrup based on the weight of the composition.

In a preferred embodiment, the confectionery composition comprises a sugar mix and the confectionery composition comprises, based on the weight of the confectionery composition, 0.0 wt % to 20 wt % sucrose, 5.0 wt % to 25 wt % glucose syrup and 20 wt % to 55 wt % fructose glucose syrup in the aqueous phase.

In a preferred embodiment, the confectionery composition comprises a sugar mix and the confectionery composition comprises, based on the weight of the confectionery composition, 0.0 wt % to 15 wt % sucrose, 7.5 wt % to 20 wt % glucose syrup and 25 wt % to 50 wt % fructose glucose syrup in the aqueous phase.

In a preferred embodiment, the confectionery composition comprises a sugar mix and the confectionery composition comprises, based on the weight of the confectionery composition, 0.0 wt % to 15 wt % sucrose, 7.5 wt % to 15 wt % glucose syrup and 30 wt % to 45 wt % fructose glucose syrup in the aqueous phase.

As a further definition, this mixture of sugars in the confectionery may also be defined as a percentage of reducing sugars, because sucrose is a non-reducing sugar while glucose/dextrose and fructose are reducing sugars. Accordingly, the sugar in the aqueous phase preferably comprises at least 10% to 100% reducing sugars, with the remainder being non-reducing sugars. In some embodiments, the sugar comprises 25% to 90% reducing sugars, 35% to 85% reducing sugars, or 40% to 70% reducing sugars. The Examples demonstrate the use of a sugar mixture comprising a range of reducing sugars. The mixture of reducing sugar and non-reducing sugar can be provided as a partially-inverted sugar syrup.

A fully hydrolysed (~97% inverted) invert syrup, in which essentially all sucrose is broken down to dextrose and fructose, may crystallise in the products of the invention. A partially hydrolysed syrup, for example hydrolysis above 10% but below 70%, preferably less than 60% hydrolysed (inverted) is more stable according to the present invention and does not crystallise.

In one embodiment, the sugar comprises or consists of partially hydrolysed invert syrup. In another embodiment, the sugar comprises or consists of a mix of sucrose, partially or fully-inverted syrup, and glucose. In a further embodiment, the sugar comprises or consists of a mixture of sucrose, fructose and glucose.

The “221” partially inverted sugar syrup used in some of the Examples is available from British Sugar plc, Peterborough, United Kingdom as “Partial Invert Syrup 221”. It is a pale straw-coloured solution of white sugar in potable water, produced from sugar beet. This syrup comprises 41-49% reducing sugars as determined by Lane & Eynon titration using Fehlings solution and Methylene blue indicator. Invert 221 is a partially inverted sugar syrup so comprises a proportion of non-hydrolysed sucrose along with equal fractions of fructose and dextrose. Compared to fully inverted sugar syrup (only fructose and dextrose) it is less prone to crystallise.

An alternative to IS221 is a mix of sucrose, and fructose-glucose syrup.

Accordingly, a mixture of sugars is preferably used according to the invention. Preferably the mixture comprises fructose.

Invert sugar may be fully inverted sugar syrup or, preferably, partially inverted sugar syrup.

Fully inverted sugar syrup comprises only glucose and fructose. Partially-inverted sugar syrup comprises glucose, fructose and sucrose and is preferred. Accordingly, a balance or mixture of sugars is preferably provided.

In a preferred embodiment, the sugars of the confectionery composition comprises a mixture of sucrose, inverted syrup (itself containing sucrose, glucose and fructose) and glucose.

### Protein

The composition of the present invention comprises protein in an amount between 0.5 wt % to 15 wt %.

The protein ingredient is preferably present as 0.5 wt % to 13 wt % of the total ingredients. The range may in some embodiments be 0.5 wt % to 12.5 wt %, or 0.5 wt % to 12.0 wt %. In an embodiment, the confectionery composition comprises proteins between 0.5 wt % to 11.5 wt %, for example between 0.5 wt % and 11 wt %. In some embodiments, the proteins are present at between 0.5 wt % and 10.5 wt %. In preferred embodiments, the proteins are present at between 0.5 wt % and 10.0 wt %, preferably between 0.5 wt % and 9.5 wt %, most preferably between 0.75 wt % and 9.0 wt %. These percentages relate to the total protein, not the percentages of the total ingredients comprising protein. Proteins can be added as a separate ingredient, or as part of an ingredient that comprising protein (e.g., milk powder).

In some preferred embodiments, the protein comprises, consists or consists essentially of dairy proteins. Dairy proteins can conveniently be provided as milk powder, for example skimmed milk powder. Other dairy protein powders include whey protein isolate powder or whey protein concentrate powder, which terms are known in the art. Whey protein isolate contains a high proportion of whey protein, preferably around 90 wt %, so can conveniently be used. Whey protein concentrate typically contains around 80 wt % whey protein and can also be used. Dairy proteins may also be provided as a liquid, for example in the form of condensed milk, preferably sweetened condensed milk. Proteins can also be provided as plant proteins. One particularly favourable plant protein is fava protein or fava bean protein. Another favourable plant protein is pea protein.

Proteins are able to emulsify fat and stabilise the droplets. The examples of the present invention have been carried out primarily with skimmed milk powder (SMP) but trials using plant-based alternatives also performed well. Preferably, the plant-derived protein may be selected from hemp, flax, amaranth, legumes such as peas, beans, soy, lentils, chickpeas, or peanuts, tree nuts such as almond and hazelnut, and grains such as rice, wheat or barley. In particularly preferred embodiments, the plant proteins are selected from legume (pea or fava). The invention is not limited to the use of SMP or plant proteins, and other protein sources can be used. For example, other milk-based protein preparations such as renett casein and sweetened condensed milk can be used.

Another protein source is whey protein. This may be provided by whey protein isolate or whey protein concentrate, which terms are known in the art.

An example of whey protein isolate (WPI) is BiPRO® 9500, commercially available from Agropur Inc., Eden Prairie, MN 55344 USA. Whey protein isolate such as BiPRO® 9500 preferably is manufactured from fresh, sweet dairy whey that is concentrated and spray dried. Whey protein isolate is preferably lactose-free based on US regulatory labelling of sugars and carbohydrates in products that contain less than 0.5 g per serving as “Og” or “Sugar Free”. Whey protein isolate preferably comprises a maximum of 3 wt % ash, 1 wt % fat, 0.5 wt % lactose and 5 wt % moisture. Whey protein isolate preferably comprises primarily beta-lactoglobulin and alpha-lactalbumin, at around 85 wt % to 95 wt % (e.g. 90 wt %) protein.

Another commercially-available whey protein isolate that can be used according to the invention is the “WPI” product available from Sachsenmilch Leppersdorf GmbH, Leppersdorf, Germany. This preferably contains around 0.1 wt % fat, around 90 wt % protein (around 92 wt % of the dry matter), around 1.8 wt % lactose, up to 3 wt % ash and 4 wt % water.

An example of whey protein concentrate (WPC) is the WPC80 product that is commercially available from Fonterra, Heerenveen, Netherlands. WPC is preferably around 75 wt % to 85 wt % protein (e.g. around 80 wt %) and comprises small amounts of fat (e.g. 5 wt %), moisture (e.g. 5 wt %), ash (e.g. 3 wt %) and lactose (e.g. 5 wt %).

In a preferred embodiment, the proteins comprise, consist or consist essentially of: (i) dairy proteins, optionally provided as milk powder and/or condensed milk; and/or (ii) plant proteins, optionally fava protein and/or pea protein.

Protein can be added to the composition both in hydrated and dehydrated forms. In a preferred embodiment, the protein in the confectionery composition is a skimmed milk powder. In a more preferred embodiment, the skimmed milk powder is rehydrated with water to provide the protein component.

### Process

A process for forming the composition comprises providing an aqueous solution of sugar, addition of hydrocolloid and protein to the aqueous solution, addition of fat and any other ingredients, blending the mixture, preferably to provide a mixture with the viscosity of between 4 and 40 Pa·S⁻¹ when measured at 25° C.

In an embodiment the aqueous sugar solution is a mixture of sugar and water.

In a preferred embodiment, the aqueous sugar solution is a sugar syrup.

In an embodiment, the process for forming the composition comprises providing an aqueous solution of sugar; adding a hydrocolloid and blending to form a first mixture; then heating the first mixture until it is 80-89° Brix; adding protein to form a second mixture, preferably to provide a second mixture with a Brix of 76-81° Brix; adding fat and any other ingredients; blending the mixture until the viscosity is between 4 and 40 Pa·S⁻¹ when measured at 25° C.; optionally heating to at least 80° C.; and allowing to cool.

In an embodiment, the first mixture is heated until it is between 80 and 89 Brix. In a preferred embodiment, the Brix value of the first mixture is between 82 and 88° Brix, preferably between 83 and 87° Brix, most preferably between 85 and 87° Brix.

The skilled person will be aware thatDegrees Brix (symbol® Bx) is the sugar content of an aqueous solution. One degree Brix is 1 gram of sucrose in 100 grams of solution and represents the strength of the solution as percentage by mass. TheDegrees Brix can be measured, for example, by refractometer.

In a preferred embodiment the blending is performed at high shear. A person skilled in the art would understand how to control shear in different mixes and would therefore be able to regulate the shear speed to what gives optimal mixing of ingredients.

In a preferred embodiment, the protein source is rehydrated and is added as an aqueous solution. In a more preferred embodiment, the protein is rehydrated in a 1:1 ratio in water before addition to the first mixture.

Optionally, the first mixture is heated to between 65 and 100° C., preferably between 75 and 100° C., most preferably between 8° and 100° C., before the addition of protein. The first mixture can be heated for greater than 1 minute, preferably greater than 2 minutes, most preferably greater than 5 minutes, preferably less than 90 minutes, more preferably less than 60 minutes, most preferably less than 30 minutes.

In a preferred embodiment, the confectionery composition is heated again, after the addition of the fat and blending, to between 6° and 90° C., preferably between 7° and 90° C., most preferably to between 75 and 90° C. for at least 30 seconds, preferably at least 1 minute, most preferably at least 2 minutes, preferably less than 10 minutes, more preferably less than 7 minutes, most preferably less than 5 minutes.

In a preferred embodiment, the Brix of the second mixture before that fat ingredients are added is between 70 and 85 Brix. In a preferred embodiment, the Brix value of the confectionery composition prior to the addition of the fat is between 73 and 83 Brix, preferably between 75 and 81 Brix, most preferably between 77 and 79 Brix. The skilled person will be aware thatDegrees Brix (symbol® Bx) is the sugar content of an aqueous solution. One degree Brix is 1 gram of sucrose in 100 grams of solution and represents the strength of the solution as percentage by mass. TheDegrees Brix can be measured, for example, by refractometer. 77 and 81° Brix, more preferably 77 and 80° Brix, most preferably 77 and 79° Brix.

In a preferred embodiment, fat is added with any other ingredients to the second mixture and blended, preferably at high shear, until the viscosity is between 4 and 40 Pa·S⁻¹ when measured at 25° C., more preferably between 10 and 37 Pa·S, most preferably 10 and 35 Pa·S or 10 and 32 Pa·S. In some embodiments, chocolate is added at the same time as protein, and before fat is added.

In another embodiment, the process for forming the composition comprises providing an aqueous solution of sugar; adding a hydrocolloid and optionally rehydrated protein to form a first mixture, blending and heating to provide a Brix of between 76 and 81° Brix; adding fat and any other ingredients to form a second mixture; blending the mixture until the viscosity is between 4 and 40 Pa·S⁻¹ when measured at 25° C.; optionally heating to at least 80° C.; and allowing to cool. In this embodiment, where the protein is rehydrated, the protein can be rehydrated at any step prior to the addition to the first mixture (for example, the protein can be rehydrated as a first step, with the sugar and hydrocolloid added after to form a first mixture after blending (i.e., the order of addition of ingredients before heating the first mixture is not limiting). In a preferred embodiment, the first mixture heated to between 65 and 100° C., preferably between 75 and 100° C., most preferably between 8° and 100° C. until the Brix is between 77 and 81° Brix, more preferably 77 and 80° Brix, most preferably between 77 and 79° Brix. In a preferred embodiment, fat is added with any other ingredients to the second mixture and blended, preferably at high shear, until the viscosity is between 4 and 40 Pa·S⁻¹ when measured at 25° C., more preferably between 10 and 37 Pa·S, most preferably 10 and 35 Pa·S or 10 and 32 Pa·S. In a preferred embodiment, the first mixture is heated to between 65 and 100° C., preferably between 75 and 100° C., most preferably between 8° and 100° C., before the addition of protein. The first mixture can be heated for greater than 1 minute, preferably greater than 2 minutes, most preferably greater than 5 minutes, preferably less than 90 minutes, more preferably less than 60 minutes, most preferably less than 30 minutes. In a preferred embodiment, the second mixture is heated again after the addition of the protein to between 6° and 90° C., preferably between 7° and 90° C., most preferably to between 75 and 90° C. for at least 30 seconds, preferably at least 1 minute, most preferably at least 2 minutes, preferably less than 10 minutes, more preferably less than 7 minutes, most preferably less than 5 minutes.

In an embodiment, after the addition of fat and blending, the mixture is allowed to cool to room temperature or lower, optionally to between 10° C. and 19° C., to 8° C. or lower, or to between 0° C. and 4° C. Room temperature is typically 20-25° C., for example about 20, 21, 22, 23, 24 or 25° C. Preferably, room temperature is 20° C.

In some embodiments cooling the composition below room temperature, in particular refrigeration to between 0° C. and 8° C., is not carried out.

In a preferred embodiment, after the addition of fat and blending, the mixture is allowed to cool to less than 80° C., preferably less than 70° C., more preferably less than 60° C., most preferably less than 50° C., greater than 5° C., preferably greater than 15° C., most preferably greater than 25° C., between 5° C. and 80° C., preferably between 15° C. and 70° C., more preferably between 15° C. and 55° C., most preferably between 20° C. and 40° C.

In an embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 80-89° Brix, adding protein and water to the
   blended sugar and hydrocolloid so that the mixture is 76-81° Brix;
   Or
   Adding a hydrocolloid and protein and blending and heating the blended sugar, hydrocolloid, protein until the mixture is 76-81° Brix;
   Adding fat and any other ingredients;
   Blending the mixture until the viscosity of the composition is between 4 and 40 Pa·S⁻¹ when measured at 25° C.;
   Optionally heating the blended composition to at least 80° C.; and Allowing the composition to cool.

In an embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 80-89° Brix, adding protein and water to the blended sugar and hydrocolloid so that the mixture is 76-81° Brix;
Or
   Adding a hydrocolloid and protein and blending and heating the blended sugar, hydrocolloid, protein until the mixture is 76-81° Brix;
   Adding fat and any other ingredients;
   Blending the mixture until the viscosity of the composition is between 4 and 40 Pa·S⁻¹ when measured at 25° C.;
   Optionally heating the blended composition to at least 80° C.; and
   Allowing the composition to cool.
Wherein the protein is a pre-mixed protein containing powder and water in a 1:1 ratio.

In an embodiment, the present invention provides a process comprising, consisting or consisting essentially of the following steps:
Providing an aqueous solution of sugar and either;
Adding a hydrocolloid and blending, heating the blended sugar and hydrocolloid until the mixture is 84-88° Brix, adding protein and water to the blended sugar and hydrocolloid so that the mixture is 77-80° Brix;
Or
Adding a hydrocolloid and protein and blending and heating the blended sugar, hydrocolloid, protein until the mixture is 77-80° Brix;
Adding fat and any other ingredients;
Blending the mixture until the viscosity of the composition is between 4 and 40 Pa·S⁻¹ when measured at 25° C.;
Optionally heating the blended composition to at least 80° C.; and
Allowing the composition to cool;
Wherein the protein is a pre-mixed protein containing powder and water in a 1:1 ratio.

In a preferred embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 84-88° Brix, adding protein and water to the blended sugar and hydrocolloid so that the mixture is 77-79° Brix;
   Or
   Adding a hydrocolloid and protein and blending and heating the blended sugar, hydrocolloid, protein until the mixture is 77-79° Brix; Adding fat and any other ingredients;
   Blending the mixture until the viscosity of the composition is between 10 and 40 Pa·S⁻¹ when measured at 25° C.;
   Optionally heating the blended composition to at least 80° C.; and
   Allowing the composition to cool;
Wherein the protein is a pre-mixed protein containing powder and water in a 1:1 ratio.

In a preferred embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 84-88° Brix, adding protein and water to the blended sugar and hydrocolloid so that the mixture is 77-79° Brix;
   Or
   Adding a hydrocolloid and protein and blending and heating the blended sugar, hydrocolloid, protein until the mixture is 77-79° Brix; Adding fat and any other ingredients;
   Blending the mixture until the viscosity of the composition is between 10 and 35 Pa·S⁻¹ when measured at 25° C.;
   Optionally heating the blended composition to at least 80° C.; and
   Allowing the composition to cool;
Wherein the protein is a pre-mixed protein containing powder and water in a 1:1 ratio.

In a more preferred embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 84-88° Brix, adding protein and water to the blended sugar and hydrocolloid so that the mixture is 77-79° Brix;
   Or
   Adding a hydrocolloid and protein and blending and heating the blended sugar, hydrocolloid, protein until the mixture is 77-79° Brix; Adding fat and any other ingredients;
   Blending the mixture until the viscosity of the composition is between 10 and 35 Pa·S⁻¹ when measured at 25° C.;
   Optionally heating the blended composition to at least 80° C.; and
   Allowing the composition to cool;
Wherein the protein is a pre-mixed skimmed milk powder and water in a 1:1 ratio and the hydrocolloid is a starch.

In the most preferred embodiment, the present invention provides a process comprising, consisting or consisting essentially of the following steps:
Providing an aqueous solution of sugar and either;
   Adding a hydrocolloid and blending, heating the blended sugar and hydrocolloid until the mixture is 84-88° Brix, adding protein and water to the blended sugar and hydrocolloid so that the mixture is 77-79° Brix;
   Or
   Adding a hydrocolloid and protein and blending and heating the blended sugar, hydrocolloid, protein until the mixture is 77-79° Brix; Adding fat and any other ingredients;
   Blending the mixture until the viscosity of the composition is between 10 and 35 Pa·S⁻¹ when measured at 25° C.;
   Optionally heating the blended composition to at least 80° C.; and
   Allowing the composition to cool to between 25 and 45° C.;
Wherein the protein is a pre-mixed skimmed milk powder and water in a 1:1 ratio and the hydrocolloid is a starch.

In an embodiment the invention provides a confectionery composition comprising water, one or more sugars and one or more fats, wherein the confectionery composition is made by combining ingredients comprising: hydrocolloid at 0.1 wt % to 10 wt % of the total ingredients; protein forming 0.5 wt % to 15 wt % of the total ingredients; ingredients forming a fat phase at 3 wt % to 30 wt % of the total ingredients; and ingredients forming a water phase at 50 wt % to 85 wt % of the total ingredients.

In some embodiments, the confectionery composition is made by combining ingredients comprising: hydrocolloid at 0.5 wt % to 7 wt % of the total ingredients; protein forming 1 wt % to 12 wt % of the total ingredients; ingredients forming a fat phase at 5 wt % to 30 wt % of the total ingredients; and ingredients forming a water phase at 50 wt % to 95 wt % of the total ingredients.

### Finished Product

In a preferred embodiment, the confectionery composition is a filling for a confectionery product.

In a more preferred embodiment, the confectionery composition is a filling for a chocolate or compound product, preferably a filled tablet or shell.

In the most preferred embodiment, the shell or tablet is a chocolate or chocolate-analogue, e.g. chocolate compound. These terms are well known in the art, but definitions are provided below.

In an embodiment, compositions of the invention may usefully be chocolate products (as defined herein), more usefully be chocolate or a chocolate compound. Independent of any other legal definitions that may be used compositions of the invention that comprises a cocoa solids content of from 25% to 35% by weight together with a milk ingredient (such as milk powder) may be informally referred to herein as ‘milk chocolate’ (which term also encompasses other analogous chocolate products, with similar amounts of cocoa solids or replacements therefor). Independent of any other legal definitions that may be used compositions of the invention that comprises a cocoa solids content of more than 35% by weight (up to 100% (i.e. pure cocoa solids) may be informally referred to herein as ‘dark chocolate’ (which term also encompasses other analogous chocolate products, with similar amounts of cocoa solids or replacements therefor). Dark chocolate may include Sucrose, Cocoa Mass, Cocoa Butter, Fat Milk Anydrous, Lecithin Rapeseed, Medium Chain Triglycerides (Flavour), Vanilla Extract, Ethanol (Ethyl Alcohol. The term ‘chocolate’ as used herein denotes any product (and/or component thereof if it would be a product) that meets a legal definition of chocolate in any jurisdiction and also include product (and/or component thereof) in which all or part of the cocoa butter (CB) is replaced by cocoa butter equivalents (CBE) and/or cocoa butter replacers (CBR).

The term ‘chocolate compound’ as used herein (unless the context clearly indicates otherwise) denote chocolate like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids.

The term ‘chocolate product’ as used herein denote chocolate, compound and other related materials that comprise cocoa butter (CB), cocoa butter equivalents (CBE), cocoa butter replacers (CBR) and/or cocoa butter substitutes (CBS). Thus, chocolate product includes products that are based on chocolate and/or chocolate analogues, and thus for example may be based on dark, milk or white chocolate.

Unless the context clearly indicates, otherwise it will also be appreciated that in the present invention, any one chocolate product may be used to replace any other chocolate product and neither the term chocolate nor compound should be considered as limiting the scope of the invention to a specific type of chocolate product. Preferred chocolate product comprises chocolate and/or compound, more preferred chocolate product comprises chocolate, most preferred chocolate product comprises chocolate as legally defined in a major jurisdiction (such as Brazil, EU and/or US).

### Preferred Embodiments

Preferred embodiments of the invention are set out below.

A confectionery composition comprising hydrocolloid in an amount of 0.2 wt % to 5 wt %, protein in an amount of 0.5 wt % to 10 wt %, water in an amount of 10 wt % to 33 wt %, sugar in an amount of 35 wt % to 70 wt % and fat in an amount of 6 wt % to 29.5 wt %, wherein the percentages are the weight percentages of the confectionery composition.

A confectionery composition comprising hydrocolloid in an amount of 0.3 wt % to 4 wt %, protein in an amount of 0.5 wt % to 9.5 wt %, water in an amount of 10 wt % to 31 wt %, sugar in an amount of 35 wt % to 65 wt % and fat in an amount of 6 wt % to 29 wt %.

A confectionery composition comprising hydrocolloid in an amount of 0.5 wt % to 3.5 wt %, protein in an amount of 0.75 wt % to 9 wt %, water in an amount of 12 wt % to 30 wt %, sugar in an amount of 40 wt % to 60 wt % and fat in an amount of 7 wt % to 28 wt %.

A confectionery composition comprising hydrocolloid in an amount of 0.1 wt % to 5 wt %, protein in an amount of 0.5 wt % to 6.5 wt %, sugar in an amount of 30 wt % to 67 wt % and fat in an amount of 2 wt % to 49 wt %, relative to the weight of the confectionery composition. Water may be present in an amount of 10 wt % to 20 wt %.

A confectionery composition comprising hydrocolloid in an amount of 0.1 wt % to 10 wt %, protein in an amount of 1.7 wt % to 15 wt %, sugar in an amount of 29.7 wt % to 80 wt % and fat in an amount of 2 wt % to 35 wt %, relative to the weight of the confectionery composition. Water may be present in an amount of 10 wt % to 40 wt %.

A confectionery composition comprising hydrocolloid in an amount of 0.1 wt % to 5 wt %, protein in an amount of 1.7 wt % to 6.5 wt %, sugar in an amount of 29.7 wt % to 67 wt % and fat in an amount of 2 wt % to 49 wt %, relative to the weight of the confectionery composition. Water may be present in an amount of 2 wt % to 20 wt %.

A confectionery composition comprising hydrocolloid in an amount of 0.2 wt % to 5 wt %, protein in an amount of 0.5 wt % to 10 wt %, water in an amount of 10 wt % to 33 wt %, sugar in an amount of 35 wt % to 70 wt % and fat in an amount of 6 wt % to 29.5 wt %, wherein the viscosity of the composition is between 4 and 40 Pa·S⁻¹ when measured at 25° C.

A confectionery composition comprising hydrocolloid in an amount of 0.3 wt % to 4 wt %, protein in an amount of 0.5 wt % to 9.5 wt %, water in an amount of 10 wt % to 31 wt %, sugar in an amount of 35 wt % to 65 wt % and fat in an amount of 6 wt % to 29 wt %, wherein the viscosity of the composition is between 10 and 40 Pa·S⁻¹ when measured at 25° C.

A confectionery composition comprising hydrocolloid in an amount of 0.5 wt % to 3.5 wt %, protein in an amount of 0.75 wt % to 9 wt %, water in an amount of 12 wt % to 30 wt %, sugar in an amount of 40 wt % to 60 wt % and fat in an amount of 7 wt % to 28 wt %, wherein the viscosity of the composition is between 10 and 35 Pa·S⁻¹ when measured at 25° C.

A confectionery composition comprising hydrocolloid in an amount of 0.2 wt % to 5 wt %, protein in an amount of 0.5 wt % to 10 wt %, water in an amount of 10 wt % to 33 wt %, sugar in an amount of 35 wt % to 70 wt % and fat in an amount of 6 wt % to 29.5 wt %, wherein the confectionery composition has a Brix value of between 73 and 83° Brix and a bulk viscosity of between 4 Pa·S to 40 Pa·S.

A confectionery composition comprising hydrocolloid in an amount of 0.3 wt % to 4 wt %, protein in an amount of 0.5 wt % to 9.5 wt %, water in an amount of 10 wt % to 31 wt %, sugar in an amount of 35 wt % to 65 wt % and fat in an amount of 6 wt % to 29 wt %, wherein the confectionery composition has a Brix value of the is between 75 and 81° Brix and a bulk viscosity of between 7 Pa·S to 35 Pa·S.

A confectionery composition comprising hydrocolloid in an amount of 0.5 wt % to 3.5 wt %, protein in an amount of 0.75 wt % to 9 wt %, water in an amount of 12 wt % to 30 wt %, sugar in an amount of 40 wt % to 60 wt % and fat in an amount of 7 wt % to 28 wt %, wherein the confectionery composition has a Brix value of the is between 77 and 79° Brix and a bulk viscosity of between 10 Pa·S to 35 Pa·S.

A confectionery composition comprising hydrocolloid in an amount of 0.2 wt % to 5 wt %, protein in an amount of 0.5 wt % to 10 wt %, water in an amount of 10 wt % to 33 wt %, sugar in an amount of 35 wt % to 70 wt % and fat in an amount of 6 wt % to 29.5 wt %, wherein the fat comprises a fat with a SFC at 20° C. of from 10 to 75%, a SFC at 25° C. of from 5% to 70% and a SFC at 30° C. of from 0 to 45%, wherein the confectionery composition has a Brix value of between 73 and 83° Brix and a bulk viscosity of between 4 Pa·S to 40 Pa·S, wherein at least a portion of the sugar is dissolved in the water to form an aqueous phase where the sugars present in the aqueous phase contribute from 50 wt % to 100 wt % of the total sugars.

A confectionery composition comprising hydrocolloid in an amount of 0.3 wt % to 4 wt %, protein in an amount of 0.5 wt % to 9.5 wt %, water in an amount of 10 wt % to 31 wt %, sugar in an amount of 35 wt % to 65 wt % and fat in an amount of 6 wt % to 29 wt %, wherein at least a portion of the sugar is dissolved in the water to form an aqueous phase where the sugars present in the aqueous phase contribute from 55 wt % to 100 wt % of the total sugars.

A confectionery composition comprising hydrocolloid in an amount of 0.5 wt % to 3.5 wt %, protein in an amount of 0.75 wt % to 9 wt %, water in an amount of 12 wt % to 30 wt %, sugar in an amount of 40 wt % to 60 wt % and fat in an amount of 7 wt % to 28 wt %, wherein the confectionery composition has a Brix value of the is between 77 and 79° Brix and a bulk viscosity of between 10 Pa·S to 35 Pa·S, wherein at least a portion of the sugar is dissolved in the water to form an aqueous phase where the sugars present in the aqueous phase contribute from 60 wt % to 100 wt % of the total sugars.

A confectionery composition comprising hydrocolloid in an amount of 0.2 wt % to 5 wt %, protein in an amount of 0.5 wt % to 10 wt %, water in an amount of 10 wt % to 33 wt %, sugar in an amount of 35 wt % to 70 wt % and fat in an amount of 6 wt % to 29.5 wt %, wherein the confectionery composition has a Brix value of between 73 and 83° Brix and a bulk viscosity of between 4 Pa·S to 40 Pa·S, wherein at least a portion of the sugar is dissolved in the water to form an aqueous phase where the sugars present in the aqueous phase contribute from 50 wt % to 100 wt % of the total sugars, wherein 15 wt % to 50 wt % of the sugar in the aqueous phase is fructose and 25 wt % to 65 wt % is glucose and/or dextrose.

A confectionery composition comprising hydrocolloid in an amount of 0.3 wt % to 4 wt %, protein in an amount of 0.5 wt % to 9.5 wt %, water in an amount of 10 wt % to 31 wt %, sugar in an amount of 35 wt % to 65 wt % and fat in an amount of 6 wt % to 29 wt %, wherein the confectionery composition has a Brix value of the is between 75 and 81° Brix and a bulk viscosity of between 7 Pa·S to 37 Pa·S, wherein at least a portion of the sugar is dissolved in the water to form an aqueous phase where the sugars present in the aqueous phase contribute from 55 wt % to 100 wt % of the total sugars, wherein 20 wt % to 40 wt % of the sugar in the aqueous phase is fructose and 30 wt % to 60 wt % is glucose and/or dextrose.

A confectionery composition comprising hydrocolloid in an amount of 0.5 wt % to 3.5 wt %, protein in an amount of 0.75 wt % to 9 wt %, water in an amount of 12 wt % to 30 wt %, sugar in an amount of 40 wt % to 60 wt % and fat in an amount of 7 wt % to 28 wt %, wherein the confectionery composition has a Brix value of the is between 77 and 79° Brix and a bulk viscosity of between 10 Pa·S to 35 Pa·S, wherein at least a portion of the sugar is dissolved in the water to form an aqueous phase where the sugars present in the aqueous phase contribute from 60 wt % to 100 wt % of the total sugars, wherein 20 wt % to 38 wt % of the sugar in the aqueous phase is fructose and 35 wt % to 55 wt % is glucose and/or dextrose.

### Examples

### SUMMARY

The inventors studied water-based fillings and prepared a range of favourable fillings. These fillings are detailed below in Tables 1 and 2. Each recipe represents a preferred embodiment of the invention. The fillings were all assessed organoleptically and it was found all Examples were smooth, creamy and indulgent to eat.

The process followed is detailed below. Examples were made using commercial kitchen equipment using the following process:

The sugar sources were combined and heated to 50° C. in a double jacketed vessel with mixing, before the starch was added. The sugar solution and starch were then mixed using a handheld high-shear mixer (Robot Coupe Mini MP 160) until there were no lumps at speed setting 4. The Brix of the solution after this step is 79° as measured using an analogue handheld refractometer at 25° C. This solution is then boiled at 100° C. until the Brix reached 86° and all of the sugar crystals were melted. The mixture was allowed to cool until the temperature reached 80° C. The milk powders were reconstituted in an equal volume of water (1:1) before they were added to the cooled sugar and starch solution, along with the fat and any other remaining ingredients. This mixture was blended at high shear using the handheld high-shear mixer for 13 minutes using speed setting 8-10. Following this mixing step, the filling mixture was pasteurised at 80° C. for 2 minutes before cooling to 40° C.

The percentages in the table below were calculated based on the final composition of the product, taking into account water loss caused by the processing steps.

For all Examples 1-15 according to the present invention, the water activity was below 0.69 when measured using a water activity meter (LabTouch AW, Novasina).

TABLE 1

| Example | 1 | 2 | 3 | 4 | 5 | 6 | |
|---|---|---|---|---|---|---|---|
| Glucose Fructose Syrup Isosweet111 | 35.6% | 33.1% | 33.0% | 28.5% | 35.3% | 35.6% | 35.8% |
| Glucose Syrup 63DE | 11.9% | 11.0% | 11.0% | 9.5% | 11.8% | 11.9% | 11.9% |
| Sugar | 2.5% | 11.0% | 11.0% | | 11.8% | 11.9% | 11.9% |
| Water | 7.9% | 7.4% | 7.3% | 7.4% | 7.8% | 7.9% | 8.0% |
| Dark Chocolate | 20.0% | | | | | | |
| White Chocolate | | | | 20.0% | | | |
| Cocoa Paste | 2.1% | | | | | | |
| Milk Skimmed Powder | 7.9% | 7.4% | 7.3% | 7.4% | 7.8% | 7.9% | 8.0% |
| Starch | 1.2% | 0.7% | 0.7% | 0.7% | 2.0% | 1.2% | 0.6% |
| Coconut Paste | | | | 20.6% | | | |
| Hazelnut Paste | | 25.0% | | | | | |
| Almond Paste | | | 25.0% | | | | |
| Glucose Syrup 39-44DE | | | | | | | |
| Cocoa butter | 5.0% | 4.4% | 4.4% | | | | |
| Fat Milk Anhydrous | 6.0% | | | 6.0% | | | |
| Flavor (Almond) | | | 0.1% | | | | |
| Trisodium Citrate | | | | | | | |
| Ertifil Max 170 (filling fat) | | | | | 23.5% | 23.7% | 23.9% |

TABLE 2

| Example | 8 | 9 | 10 | 11 | 12 | 13 | 14 | 15 |
|---|---|---|---|---|---|---|---|---|
| Glucose Fructose Syrup Isosweet111 | 38.1% | 35.3% | 37.9% | | 36.2% | 43.9% | 40.0% | 42.9% |
| Glucose Syrup 63DE | 12.7% | 11.8% | 12.6% | 12.7% | 12.1% | 14.6% | 13.3% | 19.5% |
| Sugar | 12.7% | 11.8% | 12.6% | 12.7% | 12.1% | 14.6% | 13.3% | 15.6% |
| Water | 8.5% | | 8.4% | 8.5% | 4.1% | 9.8% | 8.9% | 7.8% |
| Milk Skimmed Powder | 8.5% | | 4.3% | 8.5% | 4.1% | | | |
| Starch | 0.6% | 2.0% | 0.6% | 0.6% | 0.6% | 2.4% | 2.2% | 2.0% |
| Ertifil Max 170 (filling fat) | 18.9% | 23.5% | 18.8% | 13.5% | 21.6% | | | 7.8% |
| Sweetened Condensed Milk | | 15.7% | | | | | | |
| Ninho Powder (skimmed milk powder) | | | 4.7% | | | | | |
| Nescau Powder (malt beverage powder) | | | | 5.4% | | | | |
| Invert Sugar 221 | | | | 38.1% | | | | |
| Milo Powder (chocolate-flavoured malted powder comprising malt | | | | | 9.2% | | | |
| Barley, milk powder, sugar and cocoa plus vitamins | | | | | | | | |
| and minerals) | | | | | | | | |
| Pea Protein | | | | | | 4.9% | | |
| Chocofil TC-50 | | | | | | 9.8% | 8.9% | |
| Fava Protein | | | | | | | 8.9% | |
| Cocoa Powder | | | | | | | 4.4% | 3.9% |
| Citrus Fibre | | | | | | | | 0.6% |

### Sample Analysis

### Sugar Profile

A sugar profile of the Examples was calculated using the material specifications combined with HPLC, if/where appropriate. This is shown in Tables 5 and 6.

Examples 1-15 were made as described above. Examples 16 to 30 were the same as Examples 1-15 but have the Glucose Syrup 63DE replaced with an alternative Glucose Syrup 72DE.

### Composition Profile

The total amounts of fat, sugar, water, protein and hydrocolloid in Examples 1-15 were calculated using material product specifications (for fat, sugar, protein and hydrocolloid) and using Karl Fisher analysis for the water content. The results of this are shown in Tables 7, 8 and 9.

It should be noted that in both the sugar profile and the composition profile certain percentages may not add up to 100%. In the case of the sugar distribution, this is because there are other sugars present in smaller quantities. The sugars shown are the main ones that form the bulk of the sugar content of the fillings. In the case of the composition profile, there are other minor components that contribute to the final total (such as fibre).

TABLE 5

| Example | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Fructose | 10.2 | 9.4 | 9.4 | 8.1 | 10.1 | 10.2 | 10.2 | 10.9 | 10.1 | 10.8 | 6.6 | 10.3 | 12.5 | 11.4 | 12.2 |
| Glucose | 3.0 | 2.8 | 2.8 | 2.4 | 3.0 | 3.0 | 3.0 | 3.2 | 3.0 | 3.2 | 9.9 | 3.1 | 3.7 | 3.4 | 5.0 |
| Dextrose | 12.4 | 11.5 | 11.5 | 9.9 | 12.3 | 12.4 | 12.5 | 13.3 | 12.3 | 13.2 | 0.0 | 12.6 | 15.3 | 13.9 | 14.9 |
| Sucrose | 2.5 | 11.0 | 11.0 | 0.0 | 11.8 | 11.9 | 11.9 | 12.7 | 11.8 | 12.6 | 21.5 | 12.1 | 14.6 | 13.3 | 15.6 |
| Maltose | 4.2 | 3.9 | 3.9 | 3.4 | 4.2 | 4.2 | 4.3 | 4.5 | 4.2 | 4.5 | 3.0 | 4.3 | 5.2 | 4.8 | 6.3 |
| Other Aqueous | 1.8 | 1.7 | 1.7 | 1.5 | 1.8 | 1.8 | 1.9 | 2.0 | 1.8 | 2.0 | 1.2 | 1.9 | 2.3 | 2.1 | 2.7 |
| Sugars | | | | | | | | | | | | | | | |
| Total Composition | 48.0 | 45.2 | 45.5 | 41.9 | 47.3 | 47.7 | 48.0 | 51.1 | 50.2 | 50.3 | 58.0 | 50.4 | 53.7 | 48.9 | 56.8 |
| Sugar | | | | | | | | | | | | | | | |
| Aqueous Sugar | 34.1 | 40.5 | 40.4 | 25.4 | 43.2 | 43.5 | 43.8 | 46.6 | 43.2 | 46.4 | 42.1 | 44.3 | 53.7 | 48.9 | 56.8 |
| Total | | | | | | | | | | | | | | | |
| Aqueous Sugar % of | 71.1 | 89.6 | 88.8 | 60.6 | 91.2 | 91.2 | 91.2 | 91.2 | 86.0 | 92.1 | 72.6 | 88.0 | 100.0 | 100.0 | 100.0 |
| total sugar | | | | | | | | | | | | | | | |
| Fructose % | 29.7 | 23.3 | 23.3 | 32.1 | 23.3 | 23.3 | 23.3 | 23.3 | 23.3 | 23.3 | 15.7 | 23.3 | 23.3 | 23.3 | 21.6 |
| Aqueous phase | | | | | | | | | | | | | | | |
| sugars | | | | | | | | | | | | | | | |
| Glucose % Aqueous | 8.9 | 7.0 | 7.0 | 9.6 | 7.0 | 7.0 | 7.0 | 7.0 | 7.0 | 7.0 | 23.4 | 7.0 | 7.0 | 7.0 | 8.8 |
| phase sugars | | | | | | | | | | | | | | | |
| Dextrose % | 36.2 | 28.5 | 28.5 | 39.1 | 28.5 | 28.5 | 28.5 | 28.5 | 28.5 | 28.5 | 0.0 | 28.5 | 28.5 | 28.5 | 26.3 |
| Aqueous phase | | | | | | | | | | | | | | | |
| sugars | | | | | | | | | | | | | | | |
| Combined Glucose | 45.1 | 35.4 | 35.4 | 48.7 | 35.4 | 35.4 | 35.4 | 35.4 | 35.4 | 35.4 | 23.4 | 35.4 | 35.4 | 35.4 | 35.1 |
| and Dextrose | | | | | | | | | | | | | | | |
| Sucrose % Aqueous | 7.3 | 27.3 | 27.3 | 0.0 | 27.3 | 27.3 | 27.3 | 27.3 | 27.3 | 27.3 | 51.1 | 27.3 | 27.3 | 27.3 | 27.5 |
| phase sugars | | | | | | | | | | | | | | | |
| Maltose % Aqueous | 12.4 | 9.7 | 9.7 | 13.4 | 9.7 | 9.7 | 9.7 | 9.7 | 9.7 | 9.7 | 7.0 | 9.7 | 9.7 | 9.7 | 11.1 |
| phase sugars | | | | | | | | | | | | | | | |

TABLE 6

| Example | 16 | 17 | 18 | 19 | 20 | 21 | 22 | 23 | 24 | 25 | 26 | 27 | 28 | 29 | 30 |
|---|---|---|---|---|---|---|---|---|---|---|---|---|---|---|---|
| Fructose | 11.0 | 10.3 | 10.2 | 8.8 | 10.9 | 11.0 | 11.1 | 11.8 | 10.9 | 11.8 | 7.5 | 11.2 | 13.6 | 12.4 | 13.7 |
| Glucose | 3.4 | 3.2 | 3.2 | 2.7 | 3.4 | 3.4 | 3.4 | 3.6 | 3.4 | 3.6 | 10.3 | 3.5 | 4.2 | 3.8 | 5.6 |
| Dextrose | 12.4 | 11.5 | 11.5 | 9.9 | 12.3 | 12.4 | 12.5 | 13.3 | 12.3 | 13.2 | 0.0 | 12.6 | 15.3 | 13.9 | 14.9 |
| Sucrose | 2.5 | 11.0 | 11.0 | 0.0 | 11.8 | 11.9 | 11.9 | 12.7 | 11.8 | 12.6 | 21.5 | 12.1 | 14.6 | 13.3 | 15.6 |
| Maltose | 1.5 | 1.4 | 1.4 | 1.2 | 1.5 | 1.5 | 1.5 | 1.6 | 1.5 | 1.6 | 0.0 | 1.5 | 1.8 | 1.7 | 1.8 |
| Other Aqueous Sugars | 0.7 | 0.7 | 0.7 | 0.6 | 0.7 | 0.7 | 0.7 | 0.8 | 0.7 | 0.8 | 0.0 | 0.8 | 0.9 | 0.8 | 0.9 |
| Total Sugar | 45.4 | 42.7 | 43.1 | 39.8 | 44.7 | 45.1 | 45.3 | 48.3 | 47.6 | 47.6 | 55.2 | 47.7 | 50.5 | 46.0 | 52.5 |
| Aqueous Sugar % of | 69.5 | 89.0 | 88.2 | 58.5 | 90.7 | 90.7 | 90.7 | 90.7 | 85.2 | 91.6 | 71.3 | 87.3 | 100.0 | 100.0 | 100.0 |
| total sugar | | | | | | | | | | | | | | | |
| Fructose % Aqueous | 34.1 | 26.5 | 26.5 | 37.0 | 26.5 | 26.5 | 26.5 | 26.5 | 26.5 | 26.5 | 18.4 | 26.5 | 26.5 | 26.5 | 25.3 |
| phase sugars | | | | | | | | | | | | | | | |
| Glucose % Aqueous | 10.5 | 8.2 | 8.2 | 11.4 | 8.2 | 8.2 | 8.2 | 8.2 | 8.2 | 8.2 | 25.0 | 8.2 | 8.2 | 8.2 | 10.3 |
| phase sugars | | | | | | | | | | | | | | | |
| Dextrose % Aqueous | 38.3 | 29.7 | 29.7 | 41.5 | 29.7 | 29.7 | 29.7 | 29.7 | 29.7 | 29.7 | 0.0 | 29.7 | 29.7 | 29.7 | 27.6 |
| phase sugars | | | | | | | | | | | | | | | |
| Combined Glucose and | 48.9 | 37.9 | 37.9 | 53.0 | 37.9 | 37.9 | 37.9 | 37.9 | 37.9 | 37.9 | 25.0 | 37.9 | 37.9 | 37.9 | 38.0 |
| Dextrose | | | | | | | | | | | | | | | |
| Sucrose % Aqueous | 7.7 | 28.5 | 28.5 | 0.0 | 28.5 | 28.5 | 28.5 | 28.5 | 28.5 | 28.5 | 52.6 | 28.5 | 28.5 | 28.5 | 28.8 |
| phase sugars | | | | | | | | | | | | | | | |
| Maltose % Aqueous | 4.6 | 3.6 | 3.6 | 5.0 | 3.6 | 3.6 | 3.6 | 3.6 | 3.6 | 3.6 | 0.0 | 3.6 | 3.6 | 3.6 | 3.3 |
| phase sugars | | | | | | | | | | | | | | | |

TABLE 7

| Example | 1 | 2 | 3 | 4 | 5 | 6 | 7 |
|---|---|---|---|---|---|---|---|
| Fat Content | 18.7 | 19.4 | 18.5 | 26.4 | 23.6 | 23.7 | 23.9 |
| Sugar Content | 48.0 | 45.2 | 45.5 | 41.9 | 47.3 | 47.7 | 48.0 |
| Water Content | 19.8 | 18.4 | 18.4 | 16.8 | 19.7 | 19.8 | 19.9 |
| Protein | 4.3 | 6.7 | 7.9 | 5.7 | 2.8 | 2.9 | 2.9 |
| Content | | | | | | | |
| Hydrocolloid | 1.2 | 0.7 | 0.7 | 0.7 | 2.0 | 1.2 | 0.6 |
| Content | | | | | | | |

TABLE 8

| Example | 8 | 9 | 10 | 11 | 12 | 13 | 14 | 15 |
|---|---|---|---|---|---|---|---|---|
| Fat Content | 18.9 | 24.7 | 20.1 | 13.7 | 22.5 | 10.1 | 10.5 | 8.7 |
| Sugar Content | 51.1 | 50.2 | 50.3 | 58.0 | 50.4 | 53.7 | 48.9 | 56.8 |
| Water Content | 21.2 | 16.4 | 21.1 | 18.5 | 16.4 | 24.5 | 22.3 | 23.1 |
| Protein | 3.1 | 1.2 | 2.8 | 3.3 | 2.5 | 4.0 | 8.1 | 0.8 |
| Content | | | | | | | | |
| Hydrocolloid | 0.6 | 2.0 | 0.6 | 0.6 | 0.6 | 2.4 | 2.2 | 2.0 |
| Content | | | | | | | | |

### Solid Fat Content

For measuring the SFC values of the fats used in the present invention, the method described below were used.

For IUPAC, 2.150A, 80° C.=30 mins, 30° C.=10 mins, 0° C.=30 mins, Each Temperature=30 mins then take a reading.

For IUPAC, 2.150B, the information was taken from the supplier's product specification.

Ertifil Max 170SG - IUPAC 2.150(a)

| General description | Confectionery fat |
|---|---|
| Solid fat content (20° C.) | 23 g/100 g |
| Solid fat content (25° C.) | 14 g/100 g |
| Solid fat content (30° C.) | 9 g/100 g |

Chocofil TC50 - IUPAC 2.150(b)

| General description | Confectionery fat |
|---|---|
| Solid fat content (20° C.) | 55 g/100 g |
| Solid fat content (25° C.) | 30 g/100 g |
| Solid fat content (30° C.) | 8 g/100 g |

Cocoa Butter - IUPAC 2.150(b)

| General description | Confectionery fat |
|---|---|
| Solid fat content (20° C.) | 78 g/100 g |
| Solid fat content (25° C.) | 70 g/100 g |
| Solid fat content (30° C.) | 55 g/100 g |

Anhydrous Milk Fat - IUPAC 2.150(b)

| General description | Confectionery fat |
|---|---|
| Solid fat content (20° C.) | 21 g/100 g |
| Solid fat content (25° C.) | 12 g/100 g |
| Solid fat content (30° C.) | 5 g/100 g |

### Viscosity

Examples 3, 7 and 15 had preferred organoleptic properties on consumption. The viscosity of these was measured at 25° C. using a rheometer with oscillatory rheolometry as described below. The viscosity of these Examples is shown in Table 10.

The measurements were performed using a Physica MRC 500 rheometer (Anton Paar) equipped with a sanded Couette geometry (CC27-SN23479) and a Peltier system for temperature control. The Couette geometry was composed of a cup (14.46 mm radius) and a bob system (13.33 mm radius,40 mm length). Samples were covered with a low-viscosity silicone oil (Sigma Aldrich Ltd, Singapore) to avoid evaporation during measurements. The sample rested for 5 minutes at 25° C. before starting the experiments. The imposed frequency (1 Hz) and strain (0.5%) during oscillatory shear measurements were chosen within the linear response regime.

| | Example | | |
|---|---|---|---|
| | 3 | 7 | 15 |
| Viscocity (Pa · S) | 30.6 | 13.5 | 25.3 |

Examples 3, 7 and 15 had a viscosity that was within the range required to remain processable using current industrial equipment and processes.

Examples 31 to 33 were prepared according to the invention. All comprise fat (2 to 49 wt %), protein (1.7 to 6.5 wt %), sugars (29.7 to 67 wt %) and water. No starch is added as a separate ingredient.

| | | Ex. 32: | |
|---|---|---|---|
| | | White | Ex. 33: |
| | Ex. 31: | Recipe | White |
| | Chocolate | (High Fat, | Recipe |
| | Recipe | High SCM) | (High Fat, |
| | (High SMP, | White | High SCM) |
| Ingredient | High Fat) | Chocolate | Milk |
| Glucose Syrup | 9.48 | 9.48 | 11.86 |
| Invert Syrup | 28.45 | 28.45 | 35.56 |
| Vegetable Fat | 18.34 | 5.72 | 22.92 |
| Sugar | 12.29 | 12.29 | 15.36 |
| Skimmed Milk Powder | 5.72 | 18.34 | 7.15 |
| Water | 5.72 | 5.72 | 7.15 |
| Dark or | 20 | 20 | |
| White Chocolate | | | |
| Cacapava | | | |
| Total | 100.00 | 100.00 | 100.00 |
| Milk Flavour | | | 0.16 |

Examples 34 to 38 were prepared according to the invention.

Example 34 had a white chocolate shell, white chocolate coconut ganache filling, and milk chocolate back-off layer. Toasted coconut inclusions were included in the back-off.

Example 35 had a milk chocolate shell, hazelnut filling, and milk chocolate back-off layer. Inclusions were included in the back-off.

Example 36 had a dark chocolate shell, dark chocolate ganache filling, and dark chocolate back-off layer. Caramelized almond inclusions were included in the back-off.

Example 37 had a milk chocolate shell, caramel filling, and milk chocolate back-off layer. Salted caramel piece inclusions were included in the back-off.

Example 38 had a milk chocolate shell, white filling, and milk chocolate back-off layer. No inclusions were included in the back-off.

Examples 34 to 38 show that it is possible to successfully develop at kitchen & pilot plant level four filling recipes (white chocolate-coconut ganache, dark chocolate ganache, hazelnut, and caramel). The consumer test results showed that the tablets made with these fillings scored high for taste, texture, and appearance. The white chocolate-coconut ganache, dark chocolate ganache have best shelf life results up to the 6 months old.

| | Exam- | Exam- | Exam- | Exam- | Exam- |
|---|---|---|---|---|---|
| | ple 34 | ple 35 | ple 36 | ple 37 | ple 38 |
| Ingredient | % amount | | | | |
| Glucose Syrup | 9.5 | 10.99 | 11.86 | 7.89 | 11.84 |
| Glucose Fructose Syrup | 29.24 | 32.96 | 35.57 | 35.07 | 35.57 |
| Starch | 0 | 0.74 | 1.19 | | 1.19 |
| Fat Milk Anhydrous | 6 | | 6 | 7.49 | 2.00 |
| Vegetable fat | | | | | 13.67 |
| Water | 7.35 | 7.32 | 7.91 | 19.01 | 8.00 |
| Milk Skim Dried | 7.35 | 7.32 | 7.91 | 15.60 | 8.00 |
| Cocoa Butter | 5.56 | 4.39 | 5 | | |
| Deodorized | | | | | |
| Sucrose | | 10.99 | | 14.64 | 11.73 |
| Pectin, Sugar | | | | 0.20 | |
| Dark chocolate | | | 24.56 | | |
| (comprising Sucrose, | | | | | |
| Cocoa Mass, Cocoa | | | | | |
| Butter, Fat Milk | | | | | |
| Anydrous, Lecithin | | | | | |
| Rapeseed, Medium | | | | | |
| Chain Triglycerides | | | | | |
| (Flavour), Vanilla | | | | | |
| Extract, Ethanol (Ethyl | | | | | |
| Alcohol)) | | | | | |
| Oil Coconut (Carrier), | | 0.4 | | | |
| Oil Rapeseed (Carrier), | | | | | |
| Natural Flavoring | | | | | |
| Substances | | | | | |
| Coconut Paste | 15 | | | | |
| Hazelnut | | 24.9 | | | |
| TOTAL Filling | 100.00 | 100.0 | 100.00 | 100.00 | 100.00 |
| Formula (%) | | | | | |

1. A confectionery composition, comprising:
a hydrocolloid in an amount of 0.1 wt % to 10 wt %;
a protein in an amount of 0.5 wt % to 15 wt %, preferably;
water in an amount of 10 wt % to 40 wt %;
a sugar in an amount of 35 wt % to 80 wt %; and
a fat in an amount of 2 wt % to 35 wt %, wherein the percentages are weight percentages of the confectionery composition.

2. The confectionery composition according to claim 1, wherein a viscosity of the confectionery composition is between 5 Pa·S⁻¹ and 40-Pa·S⁻¹.

3. The confectionery composition according to claim 1, wherein the sugar comprises a mixture of fructose and glucose.

4. The confectionery composition according to claim 1, wherein the sugar is comprised in an aqueous phase, and from 10 wt % to 50 wt % of the sugar in the aqueous phase is fructose.

5. The confectionery composition according to claim 1, wherein the sugar is comprised in an aqueous phase, and from 20 wt % to 65 wt % of the sugar in the aqueous phase is glucose and/or dextrose.

6. The confectionery composition according to claim 1, wherein the fat comprises a filling fat, a milk fat, and/or a nut paste or butter.

7. The confectionery composition according to claim 1, wherein the fat comprises an SFC at 20° C. of at least 10%.

8. The confectionery composition according to claim 1, further comprising between 2 wt % and 35 wt % of the fat, the fat comprises an SFC at 20° C. of at least 10%.

9. The confectionery composition according to claim 1, wherein the water and the sugar form an aqueous phase comprising between 50 wt % and 95 wt % of the confectionery composition and the fat is present as a fat phase comprising between 5 wt % and 30 wt % of the confectionery composition.

10. The confectionery composition according to claim 1, wherein the sugar comprises a sugar syrup.

11. The confectionery composition according to claim 1, wherein the sugar comprises or consists of:
at least two different sugars; or
an invert sugar with a sugar conversion percentage between 10% and 70%.

12. A confectionery composition, comprising:
a hydrocolloid in an amount of 0.2 wt % to 5 wt %;
a protein in an amount of 0.5 wt % to 10 wt %;
water in an amount of 10 wt % to 33 wt %;
a sugar in an amount of 35 wt % to 70 wt %; and
a fat in an amount of 6 wt % to 29.5 wt %, wherein the percentages are weight percentages of the confectionery composition.

13. A process for making a confectionery composition, comprising:
adding a hydrocolloid and a protein to an aqueous solution of a sugar;
adding a fat and any other ingredients to the aqueous solution to form a mixture; and
blending the mixture.

14. A confectionery product comprising a confectionery composition according to claim 1, wherein the confectionary product is partly or completely surrounded or encased in a chocolate or a chocolate-analogue.
